(19) United States
(12) Patent Application Publication
(10) Pub. No.: US 2003/0093466 A1
(43) Pub. Date: May 15, 2003

(54) Drag and drop technology for remote control tool

(76) Inventors: James D. Jarman, Lehi, UT (US); Sri K. Canakapalli, American Fork, UT (US)

Correspondence Address: Timothy N. Trop, TROP, PRUNER & HU, P.C., STE 100, 8554 KATY FWY, HOUSTON, TX, 77024-1805, US

(21) Appl. No.: 10/002,794

(22) Filed: Nov. 15, 2001

(51) Int. Cl. G06F 15/16; G09G 5/00

(52) U.S. Cl. 709/203; 345/769

(57) ABSTRACT

A remote control tool may facilitate the control of a remote system on a network. A network administrator using a local system may manipulate objects on a remote system. In one embodiment of the present invention, a graphical user interface may indicate objects on the local system and the remote system. A graphical depiction of an object on either system may be then dragged and dropped to the interface associated with the other system. As a result, the object may automatically be transferred in accordance with the drag and drop operation.

### BACKGROUND

This invention relates generally to remote control tools that allow network administrators to make adjustments to processor-based systems from a remote location.

Remote control tools enable correction of items on a networked processor-based system from a remote location. The remote control tool enables remote client computers in a network to be accessed to accomplish various network administration tasks including transferring updated files and chatting with users to learn about their computer related problems. An obvious advantage of a remote control tool is that it enables a network administrator to solve some of the client computer problems without the need to physically visit the client computer.

One common task that must be implemented by network administrators is to provide various files, objects, and software modules to client computers on the network. Generally this requires a visit to the user's computer or relatively complicated process wherein the network administrator must find the file in a directory, copy the file, and transfer the file to the client computer.

Thus there is need for better ways to transfer objects to networked computers using remote control tools.

### BRIEF DESCRIPTION OF THE DRAWINGS

FIG. 1 is a schematic depiction of a network in accordance with one embodiment to the present invention;

FIG. 2 is a depiction of a remote control tool in accordance with one embodiment to the present invention;

FIG. 3 is a graphical user interface in accordance with one embodiment of the present invention;

FIG. 4 is the graphical user interface of FIG. 3 after it has been modified; and

FIG. 5 is a block depiction of the local system shown in FIG. 1 in accordance with one embodiment to the present invention.

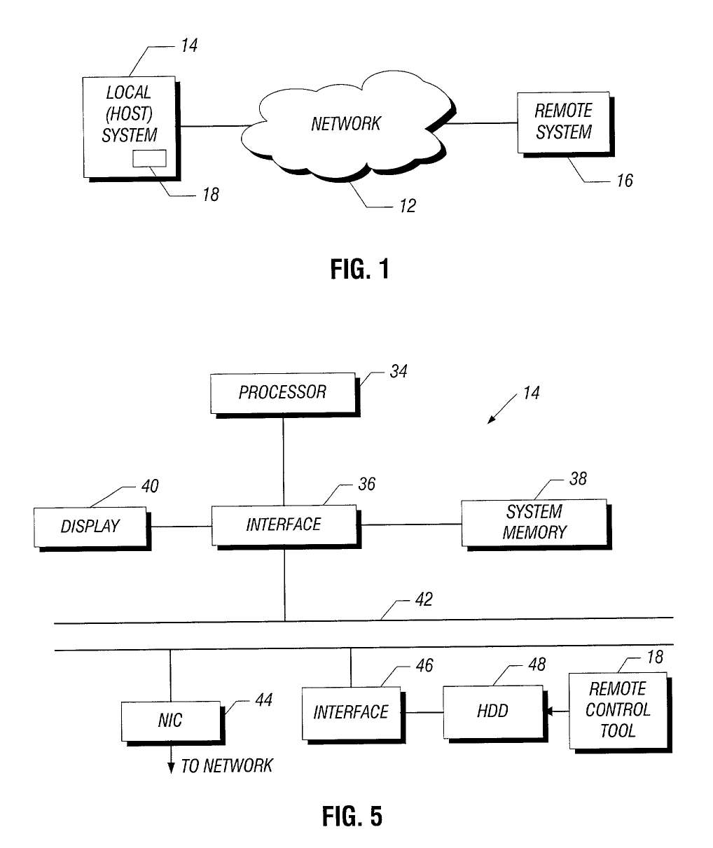

### DETAILED DESCRIPTION

A network 12 may encompass a local or host system 14 that may be operated by a network administrator and a plurality of remote systems including the system 16. The systems 14 and 16 may be processor-based systems such as desktop computers as one example. The network 12 may be a local area network (LAN), a metropolitan area network (MAN) or for that matter any network.

The local system 14 may include a remote control tool 18 that enables the local system 14 to be utilized by a network administrator to make adjustments on remote systems 16 without the need to actually physically access the systems 16. This may reduce the amount of time that is needed to make changes on a large number of remote systems 16 and may facilitate communications between the local system 14 used by the network administrator and the network users.

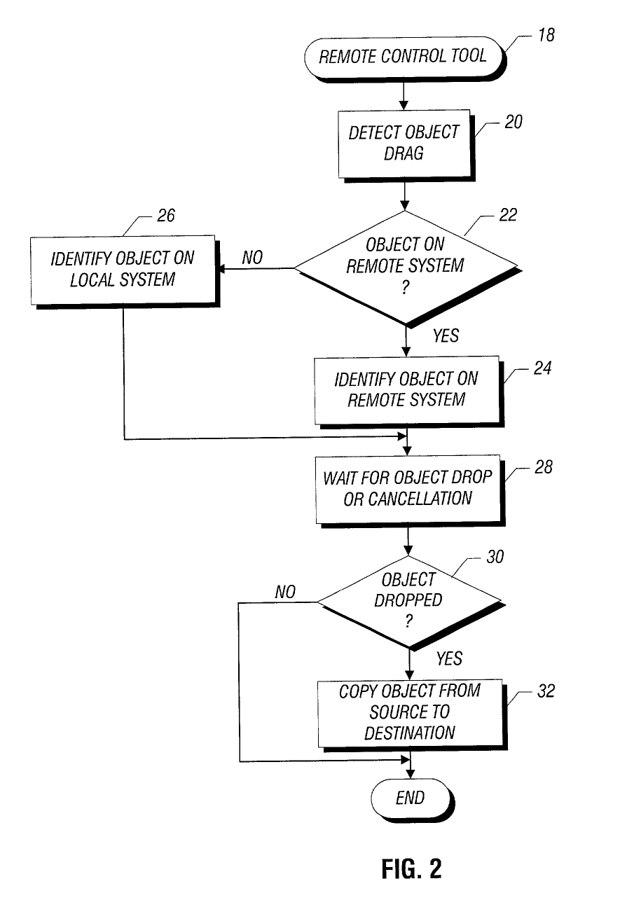

As shown in FIG. 2, the remote control tool 18 may include a drag and drop feature. The dragging of an object is detected as indicated in block 20. The object being dragged may be an image in memory, a block of text or a file to mention a few examples. The object may be dragged by simply mouse clicking on a depiction of the object on a graphical user interface associated with the local system 14. By maintaining the mouse button in the clicked down position, the object may be “dragged” across the graphical user interface.

When dragging is detected, a check at diamond 22 determines where the object being dragged is located in the system file directory. If the object is on the remote system 16, the location of the object in the system file directory on the remote system 16 is identified, as indicated in block 24. This generally involves accessing the directory or file structure of the remote system 16, using technology that is part of the remote control tool 18. Similarly, if the dragged object is on the local system 14, its location within the file system or directory system may be determined in block 26.

Once the location of the dragged object within the file or directory has been determined, the flow waits for the object to be dropped or the operation to be canceled as indicated in block 28. If the object is dropped as determined in diamond 30, the object is simply copied from the source location to the destination location, all as indicated in block 32. The destination location is indicated by the location where the object was dropped. If the object is not dropped after a period of time, then the operation has been canceled and the flow may end.

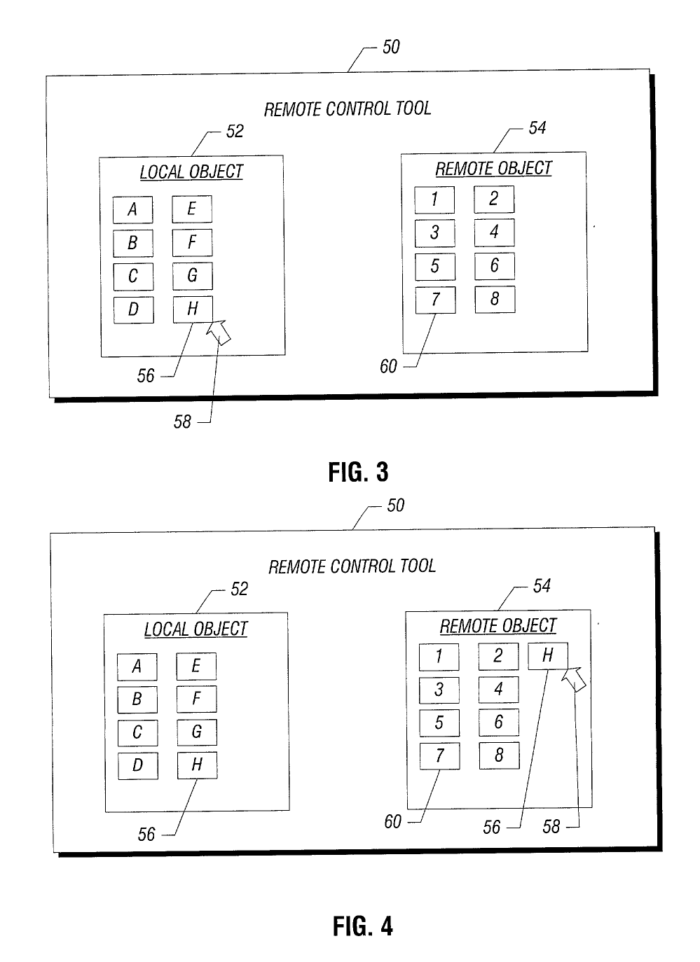

Referring to FIGS. 3 and 4, a graphical user interface for the remote control tool 18 may include a window that shows a number of objects 56. The objects 56 may be organized as local objects 52 indicating that the objects are on the local system 14 or remote objects 54 indicating that the objects are on the remote system 16. A cursor 58 may be positioned over an object 56. The object may be clicked on and a copy of the file (or the file itself) may be dragged from the local object interface 52 to the remote object interface 54. If the object is then dropped in the remote object interface 54, as indicated in FIG. 4, a copy of the object may be automatically transferred from the local system 14 to the remote system 54.

While a simplified directory structure is shown in FIGS. 3 and 4, more elaborate cascaded or tree-type directories may be provided instead. In such case, the network administrator may actually place the file in a graphical representation of a desired location, such as a particular hard disk drive or other storage area, on one or more of the systems 14 or 16.

For example, the network administrator may provide a copy of an update file from the local object interface 52 to the remote object interface 54. Conversely, a copy of an object on the remote system 16 may be transferred to a local system 14 so that the network administrator can determine why that object is not operating correctly.

With some embodiments of the present invention, objects may be readily transferred between computers, by the use of a remote control tool 18. In some embodiments, it is possible to replace the current file transfer method available in a remote control tool by making the file transfer functionality more easy to use. For example, to transfer a file from a local system 14 to a remote system 16, using the current remote control tools, one may need to operate an explorer type directory structure, get to the source file in the destination directory, and then transfer the file. With some embodiments of the present invention, one can transfer files or other objects simply by moving them between windows of different computers in any direction.

Referring finally to FIG. 5, the local system 14 used by the network administrator may include a processor 34 coupled to an interface 36. In the embodiment illustrated in FIG. 5, the interface 36 may be coupled to a display 40 that displays the graphical user interface 50, and the system memory 38.

The interface 36 may also be coupled to a bus 42. Coupled to the bus 42 may be a network interface card 44 to connect to the network 12 and another interface 46. In one embodiment, the interface 46 may be connectable to a hard disk drive 48 which may store the remote control tool 18. Of course the architecture shown in FIG. 5 is only an example and any of a variety of network and computer architectures may be utilized in other embodiments of the present invention.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
operating a remote control tool on a local processor-based system to control a remote processor-based system;
dragging an image indicating an object from a graphical user interface associated with one of said systems and dropping said image in a graphical user interface associated with the other of said systems; and
automatically placing the object at the location indicated by the graphical user interface where the image was dropped.

2. The method of claim 1 including mouse clicking on an image indicating an object.

3. The method of claim 1 including determining whether an image indicating an object is identified with the local or the remote system.

4. The method of claim 3 including identifying said object in a directory associated with one of said systems.

5. The method of claim 1 including determining whether the image indicating an object has been dropped or the operation has been canceled.

6. The method of claim 1 including determining the location on a graphical user interface where the object is dropped and correlating said location to a location for storing said object.

7. The method of claim 1 including displaying a graphical user interface including interface portions associated with the local and the remote processor-based systems.

8. The method of claim 7 including providing graphical representations of objects on the local processor-based system in a first window and objects on the remote processor-based system in a second window.

9. The method of claim 1 wherein placing the object includes transferring a copy of the object.

10. The method of claim 1 wherein placing the object includes transferring the object from one system to another system.

11. An article comprising a medium storing instructions that enables a processor-based system to:
operate a remote control tool on a local processor-based system to control a remote processor-based system;
drag an image indicating an object from a graphical user interface associated with one of said systems and drop said image in a graphical user interface associated with the other of said systems; and
automatically place the object at the location indicated by the graphical user interface where the image was dropped.

12. The article of claim 11 wherein said medium stores instructions that enable the processor-based system to identify an object when an image indicating an object is mouse clicked.

13. The article of claim 11 wherein said medium stores instructions that enable the processor-based system to determine whether an image indicating an object is identified with the local or the remote system.

14. The article of claim 13 wherein said medium stores instructions that enable the processor-based system to identify said object in a directory associated with one of said systems.

15. The article of claim 11 wherein said medium stores instructions that enable the processor-based system to determine whether the image indicating an object has been dropped or the operation has been canceled.

16. The article of claim 11 wherein said medium stores instructions that enable the processor-based system to determine the location on a graphical user interface where the object is dropped and correlate said location to a location for storing said object.

17. The article of claim 11 wherein said medium stores instructions that enable the processor-based system to display a graphical user interface including interface portions associated with the local and the remote processor-based systems.

18. The article of claim 17 wherein said medium stores instructions that enable the processor-based system to provide graphical representations of objects on the local processor-based system in a first window and objects on the remote processor-based system in a second window.

19. The article of claim 11 wherein said medium stores instructions that enable the processor-based system to place a copy of the object at the location indicated by the graphical user interface.

20. The article of claim 11 wherein said medium stores instructions that enable the processor-based system to transfer the object from one system to another system.

21. A system comprising:
a processor; and
a storage coupled to said processor, said storage storing instructions that enable the processor to operate a remote control tool to control a remote processor based system, drag an image indicating an object from a graphical user interface associated with a processor-based system, drop said image in a graphical user image associated with another processor based system and automatically place the object at the location indicated by the graphical user interface where the image was dropped.

22. The system of claim 21 wherein said storage stores instructions that enable the processor to identify an object when an image indicating an object is mouse clicked.

23. The system of claim 21 wherein said storage stores instructions that enable the processor to determine whether an image indicating an object is identified with the remote system.

24. The system of claim 23 wherein said storage stores instructions that enable the processor to identify the object in a directory associated with a processor-based system.

25. The system of claim 21 wherein said storage stores instructions that enable the processor to place a copy of the object at the location indicated by the graphical user interface.

26. The system of claim 21 wherein said storage stores instructions that enable the processor to transfer the object from the system to another system.
